(19) United States
(12) Patent Application Publication
(10) Pub. No.: US 2014/0274273 A1
(43) Pub. Date: Sep. 18, 2014

(54) SYSTEM AND METHOD FOR CONDUCTING A LOTTERY GAME

(71) Applicants: Connecticut Lottery Corporation, Rocky Hill, CT (US); Massachusetts State Lottery Commission, Braintree, MA (US)

(72) Inventors: Paul R. Sternburg, Watertown, MA (US); Diane Patterson, Middletown, CT (US)

(73) Assignees: Connecticut Lottery Corporation, Rocky Hill, CT (US); Massachusetts State Lottery Commission, Braintree, MA (US)

(21) Appl. No.: 14/179,449

(22) Filed: Feb. 12, 2014

Related U.S. Application Data
(60) Provisional application No. 61/788,499, filed on Mar. 15, 2013.

(51) Int. Cl. G07F 17/32

(52) U.S. Cl. CPC G07F 17/329
USPC 463/17

(57) ABSTRACT

The disclosed technology relates generally to a method and system for conducting a lottery drawing that includes two or more potential prizes that are tied to the life of a winner of the prize. A first prize, in certain embodiments, is a payment made in first regular installments throughout the remaining lifetime of the first prize winner and a second prize, in certain embodiments, is a payment made in second regular installments throughout the remaining lifetime of the second prize winner. In certain embodiments, the first regular installments may have a different periodicity and different value than the second regular installments.

### RELATED APPLICATIONS

The present application claims priority to U.S. Provisional Patent Application No. 61/788,499, entitled “System and Method for Conducting a Lottery Game” and filed Mar. 15, 2013 and hereby incorporated by reference.

### BACKGROUND

A lottery is a form of gambling that is often run by state governments. States are authorized to operate lottery games. States offer several types of lottery games and several states work together to offer interstate lottery games. The proceeds from lotteries are most commonly used to fund state and local programs, including, for example, local aid and public education programs. Lottery games are sold in many types of retail establishments including grocery stores, general merchandise stores, and convenience stores.

### SUMMARY

The disclosed technology relates generally to a method and system for conducting a lottery game that includes two or more potential prizes that are tied to the life of a winner of the prize. The disclosed technology, in certain embodiments, includes a method of conducting a lottery game. In certain embodiments, the method includes receiving, by a processor of a computing device, a set of randomly selected winning characters; for each of a plurality of game plays, each game play comprising a set of selected characters, determining, by a processor: (i) a number of and/or type of matches between the selected characters and the winning characters, and (ii) whether the determined number and/or type of matches between the selected characters and the winning characters qualifies for at least a first prize or a second prize; for a game play qualifying for the first prize, awarding the first prize to a first prize winner presenting the game play, wherein the first prize is a payment made in regular installments throughout the remaining lifetime of the first prize winner; and for a game play qualifying for the second prize, awarding the second prize to a second prize winner presenting the game play, wherein the second prize is a payment made in regular installments throughout the remaining lifetime of the second prize winner, wherein the regular installments of the first prize have a different periodicity than the regular installments of the second prize. In certain embodiments, the set of randomly selected winning characters includes at least one of a number, letter, and/or character.

In certain embodiments, the set of randomly selected winning characters is randomly selected using a drawing machine. In certain embodiments, the set of randomly selected winning characters is randomly selected electronically. In certain embodiments, the processor receiving the set of randomly selected winning characters is a first processor and the processor determining the number of matches is a second processor.

In certain embodiments, the periodicity of the first regular installments is daily, weekly, monthly, or yearly. In certain embodiments, the periodicity of the second regular installments is daily, weekly, monthly, or yearly. In certain embodiments, the periodicity of the first regular installments is weekly and the periodicity of the second regular installments is yearly. In certain embodiments, the set of selected characters of a game play qualifying for the first prize match the set of winning characters. In certain embodiments, the set of randomly selected winning characters includes six characters.

The disclosed technology, in certain embodiments, includes a system. In certain embodiments, the system includes a processor; and a memory having instructions stored thereon, wherein the instructions, when executed by the processor, cause the processor to: receive a set of randomly selected winning characters; for each of a plurality of game plays, each game play comprising a set of selected characters, determine: (i) a number of and/or type of matches between the selected characters and the winning characters, and (ii) whether the determined number and/or type of matches between the selected characters and the winning characters qualifies for at least a first prize or a second prize; for a game play qualifying for the first prize, award the first prize to a first prize winner presenting the game play, wherein the first prize is a payment made in first regular installments throughout the remaining lifetime of the first prize winner; and for a game play qualifying for the second prize, award the second prize to a second prize winner presenting the game play, wherein the second prize is a payment made in second regular installments throughout the remaining lifetime of the second prize winner, wherein the first regular installments have a different periodicity than the second regular installments.

The disclosed technology, in certain embodiments, includes a non-transitory computer readable medium having instructions stored thereon, wherein the instructions, when executed by a processor, cause the processor to: receive a set of randomly selected winning characters; for each of a plurality of game plays, each game play comprising a set of selected characters, determine: (i) a number of and/or type of matches between the selected characters and the winning characters, and (ii) whether the determined number and/or type of matches between the selected characters and the winning characters qualifies for at least a first prize or a second prize; for a game play qualifying for the first prize, award the first prize to a first prize winner presenting the game play, wherein the first prize is a payment made in first regular installments throughout the remaining lifetime of the first prize winner; and for a game play qualifying for the second prize, award the second prize to a second prize winner presenting the game play, wherein the second prize is a payment made in second regular installments throughout the remaining lifetime of the second prize winner, wherein the first regular installments have a different periodicity than the second regular installments.

### BRIEF DESCRIPTION OF THE FIGURES

The foregoing and other objects, aspects, features, and advantages of the present disclosure will become more apparent and better understood by referring to the following description taken in conjunction with the accompanying drawings, in which:

FIG. 1 is a flowchart of an example method for conducting a lottery game;

FIGS. 2A and 2B are illustrations of example game tickets;

FIG. 3 is an illustration of an example prize structure for a drawing;

FIG. 4 shows a block diagram of an exemplary cloud computing environment; and

FIG. 5 is a block diagram of a computing device and a mobile computing device.

The features and advantages of the present disclosure will become more apparent from the detailed description set forth below when taken in conjunction with the drawings, in which like reference characters identify corresponding elements throughout. In the drawings, like reference numbers generally indicate identical, functionally similar, and/or structurally similar elements.

### DETAILED DESCRIPTION

The disclosed technology, in some implementations, includes a lottery drawing for one or more prizes. In some implementations, the top prize is a payout on a regular basis for the life of the winner of the top prize. The top prize payout may be paid every day, week, month, year, or decade for the life of the winner of the top prize. In some implementations, the lottery drawing includes a second prize. The second prize may be a payout on a regular basis for the life of the winner of the second prize. The second prize payout may be paid every day, week, month, year, or decade for the life of the winner of the second prize.

FIG. 1 is an example flowchart of a method 100 for conducting a lottery game. In some implementations, the method 100 includes receiving a set of randomly selected winning characters (102). Characters may be numbers, letters, or symbols. In some implementations, the set of randomly selected winning characters may be randomly selected using a drawing. The set of randomly selected winning characters may be randomly selected using a drawing machine. The set of randomly selected winning characters are randomly selected electronically. In some implementations, the set of randomly selected winning characters may be randomly selected using an official drawing. In some implementations, the set of winning characters includes six characters.

In some implementations, a drawing determines whether participants in a game win a prize. In some implementations, a drawing occurs twice a week. In some implementations, the drawing includes selecting the winning characters. The winning characters may be a set of winning characters that are used to identify winners by matching the set of winning characters with a set of characters selected by a player participating in the drawing.

In some implementations, the drawing is conducted in the presence of drawing officials. In some implementations, the drawing is a formal process of selecting winning characters which determine the number of winners for each prize level of a game. In some implementations, drawing officials include a drawing director, a drawing performer, security officials, and/or a member of an independent certified public accounting firm. In some implementations, the drawing officials includes one or more of each type of official. In some implementations, the drawing director is the person in charge of the drawing production. In some implementations, the drawing performer is the person performing the drawing. In some implementations, a computer system performs the drawing. In some implementations, the security official(s) are the person(s) assigned to safeguard the drawing equipment and record all drawing activity. In some implementations, the member(s) of independent certified public accounting firm are the person(s) retained to observe and certify each drawing and to resolve any disputes concerning operation of the drawing.

In some implementations, pre-draw activities occur before a drawing. In some implementations, activities related to drawings are recorded. In some implementations, a security official records information related to the drawing as well as the drawing process on an electronic medium such as a camera or camcorder. In some implementations, recorded drawings are archived.

In some implementations, a drawing official uses a card system to randomly select a sealed ball set for use in each drawing from among those stored in inventory. A drawing official may request another drawing official to blindly choose a set of balls for a drawing. In some implementations, one or more drawing officials will use weight sheets to record the seal characters found on each ball set clasp that will be used. In some implementations, one or more drawing officials record the number (e.g. security code) found on the ball container. In some implementations, the weights of all balls used in a drawing are recorded on a test/weight sheet log. In some implementations, one or more test drawings are conducted prior to an actual drawing.

In some implementations, participants purchase a game ticket to participate in an drawing. In some implementations, game tickets may be purchased from a terminal. In some implementations, the terminal is a terminal operated by a licensed sales retailer, a player activated terminal by using a touch screen or by inserting a selection slip into the machine, a self-service terminal, a lottery subscription system, a ticket vending machine or such other similar system. Terminals include various forms of computing devices such as a personal computer, laptop, terminal computer, server, mobile computing device, or tablet computer.

In some implementations, a player may purchase a game ticket for future drawings such as an advance action in which the player purchases a game ticket for a future drawing or a multi-draw in which the user purchases a game ticket for a current drawing and a future drawing. In some implementations, a player playing a multi-draw or advance action may play the same characters in the current and future drawings or different characters.

In some implementations, game tickets include, but are not limited to, the player's character selections, game logo or game name, ticket cost, terminal number, barcode, quick pick (if selected), replay (if selected), serial number and drawing date. Game tickets may also include the selling date, time stamp and any information required for validation of game tickets.

In some implementations, a player uses a game ticket to select a set of characters for the game (e.g., a drawing). In some implementations, the selection of characters the player makes for the game is referred to as a game play. In some implementations, the player may participate in the game by electronically entering a selection of a set of characters or requesting another person enter a selection of a set of characters for the game. In some implementations, players may convey their character selections to any licensed sales retailer. The characters selected by the players may be manually entered into an on-line terminal. In some implementations, the characters selected by the players may be manually entered into an on-line terminal by the licensed sales retailer. The on-line terminal may be part of a closed system or an internet based system. In some implementations, players may utilize the barcodes of already-purchased game tickets to duplicate another game ticket of the same price and with the same character selections and options for the same drawing or a new drawing. To utilize a replay feature of a game, in some implementations, players may either make the request of a licensed sales retailer or may scan the barcode directly into a player activated or self-service terminal. In some implementations, game tickets may be purchased for future drawings. In some implementations, game tickets may be purchased by subscription.

In some implementations, the method 100 includes determining a number of matches between the set of characters selected by a participant and the set of winning characters (104). In some implementations, the method 100 includes, for each of a plurality of game plays, determining a number and/or type of matches between the selected characters and the winning characters.

In some implementations, the method 100 includes determining whether the determined number and/or type of matches between the selected characters and the winning characters qualifies a player for a prize (106). In some implementations, the prize is a first prize or a second prize. In some implementations, the set of selected characters of a game play qualifying for the first prize match the set of winning characters.

In some implementations, the player's set of characters includes a first subset of characters selected from a first group of characters and a second subgroup of characters selected from a second group of characters. In some implementations, the winning set of characters includes a first winning subset of characters selected from the first group of characters and a second winning subgroup of characters selected from the second group of characters. In some implementations, a player qualifies for the first prize if the player's set of characters matches the winning set of characters. In some implementations, a player qualifies for the second prize if the player's first subset of characters matches the first winning subset of characters and the second subset of characters does not match the second winning subset of characters. In some implementations, the first group of characters is selected from a set of characters from one to forty-three and the second group of characters is selected from a set of characters from one to forty-three.

In some implementations, the method 100 includes awarding a prize to a player associated with a winning game play (108). In some implementations, the prize includes a payout. In some implementations, the payout is based on a payout structure such as the example payout structure 300 shown in FIG. 3. In some implementations, the first prize is a payment made in first regular installments throughout the remaining lifetime of the first prize winner. In some implementations, the second prize is a payment made in second regular installments throughout the remaining lifetime of the second prize winner.

In some implementations, the periodicity of the payments for the first prize is daily, weekly, monthly, or yearly. In some implementations, the periodicity of the payments for the second prize is daily, weekly, monthly, or yearly. In some implementations, the periodicity of the first regular installment is weekly and the periodicity of the second regular installment is yearly.

In some implementations, a winner of the top prize or second prize may elect to receive a lump sum payment. In some implementations, the prize is a set payout. In some implementations, a set payout is a fixed amount of money such as the third through tenth prizes as shown in FIG. 3.

In some implementations, more than one player may win a prize, such as the top prize and/or the second prize. If multiple players win a prize, the winners may split the prize. In some implementations, there is a minimum lifetime value of the a prize if there are a large number of winners of a prize. For example, if there are a large number of top prize winners, all of the top prize winners may be guaranteed the minimum lifetime value of the top prize. In another example, if there are a large number of second prize winners, all of the second prize winners may be guaranteed the minimum lifetime value of the second prize. If there are, for example, fourteen top prize winners, the top prize, for example $7000/week for the life of the top prize winner, is split between the fourteen top prize winners such that each top prize winner will receive $500/week for the each of their respective lives. If there are, for example, ten second prize winners, the second prize, for example $25,000/year for the life of the second prize winner, is split between the ten second prize winners such that each second prize winner will receive $2,500/year for the each of their respective lives. In some implementations, the guaranteed minimum lifetime value of the top prize is not paid out if there are more than a certain number of winners. For example, if there are more than fourteen top prize winners, the top prize liability will be split equally among all the top prize winners and paid in one lump sum payment to each of the top prize winners.

In some implementations, in connection with the winning characters drawn, the holder of a winning game ticket may win only one prize per play, board or panel, and shall be entitled only to the prize won by those characters in the highest matching prize category. In some implementations, the holder of a winning game ticket may win more than one prize. In some implementations, the holder of a winning game ticket must redeem the ticket within a certain period of time. The period of time may be, for example, a week, month, year, 180 days, or 90 days from the date of the official drawing associated with the winning ticket.

In some implementations, the game is a double matrix-style game as shown in example game ticket in FIGS. 2A and 2B. FIG. 2A illustrates an example of a game ticket. In some implementations, the game includes a game ticket. In some implementations, the game ticket includes a game board 202. In some implementations, the game board 202 contains a first board 204 and a second board 210. In some implementations, each board contains a first matrix 206 and a second matrix 208. In some implementations, each board contains a quick pick 212a associated with the first matrix 206 and a quick pick 212b associated with the second matrix 208.

In some implementations, the first matrix 206 contains a first set of squares. In some implementations, the first set of squares includes forty-three squares. In some implementations, the second matrix 208 includes a second set of squares. In some implementations, the second set of squares includes forty-three squares. In some implementations, the characters available for selection by the participants in the first matrix 206 and second matrix 208 may be more or less than forty-three characters, respectively. In some implementations, the game board 202 includes one or more quick picks 212. In some implementations, players may select their own characters by completing a game board 202 or by conveying their character selections directly to any licensed sales retailer. In some implementations, if the user selects a quick pick feature 212a and/or 212b, characters are randomly selected by the computer system rather than by the player. In some implementations, players may either request a quick pick game ticket from a licensed sales retailer or may select the quick pick option (212a and/or 212b) on the game ticket and submit the completed game ticket to any licensed sales retailer.

In some implementations, a quick pick 212a is associated with the first matrix 206. The player may selected the quick pick 212a instead of selecting five squares from the first matrix 206. If the players selects quick pick 212a, a computer will select five characters from the characters represented by the first matrix 206 for the player.

In some implementations, a quick pick 212b is associated with the second matrix 208. The player may select the quick pick 212b instead of selecting a square from the second matrix 208. If the player selects quick pick 212b, a computer will select five characters from the characters represented by the second matrix 208 for the player.

In some implementations, for a drawing, participants may select, for example, five unique characters in the first matrix 206. In some implementations, participants may also select, for example, one lucky ball character in the second matrix 208. The lucky ball character may be the same as one of the first five characters selected by the player.

FIG. 2B is another example of a game ticket. In some implementations, the game ticket includes a game play 252. The game play may be the area of the play slip, also known as a “board” or “panel”. In some implementations, the game play 252 contains a first board 254 and a second board 260. In some implementations, each board contains a first matrix 256 and a second matrix 258.

In some implementations, the first matrix 256 contains a first set of squares. In some implementations, the first set of squares includes forty-three squares. In some implementations, the second matrix 258 includes a second set of squares. In some implementations, the second set of squares includes forty-three squares.

As shown in FIG. 4, an implementation of a network environment 400 for use in conducting a lottery game is shown and described. In brief overview, referring now to FIG. 4, a block diagram of an exemplary cloud computing environment 400 is shown and described. The cloud computing environment 400 may include one or more resource providers 402a, 402b, 402c (collectively, 402). Each resource provider 402 may include computing resources. In some implementations, computing resources may include any hardware and/or software used to process data. For example, computing resources may include hardware and/or software capable of executing algorithms, computer programs, and/or computer applications. In some implementations, exemplary computing resources may include application servers and/or databases with storage and retrieval capabilities. Each resource provider 402 may be connected to any other resource provider 402 in the cloud computing environment 400. In some implementations, the resource providers 402 may be connected over a computer network 408. Each resource provider 402 may be connected to one or more computing device 404a, 404b, 404c (collectively, 404), over the computer network 408.

The cloud computing environment 400 may include a resource manager 406. The resource manager 406 may be connected to the resource providers 402 and the computing devices 404 over the computer network 408. In some implementations, the resource manager 406 may facilitate the provision of computing resources by one or more resource providers 402 to one or more computing devices 404. The resource manager 406 may receive a request for a computing resource from a particular computing device 404. The resource manager 406 may identify one or more resource providers 402 capable of providing the computing resource requested by the computing device 404. The resource manager 406 may select a resource provider 402 to provide the computing resource. The resource manager 406 may facilitate a connection between the resource provider 402 and a particular computing device 404. In some implementations, the resource manager 406 may establish a connection between a particular resource provider 402 and a particular computing device 404. In some implementations, the resource manager 406 may redirect a particular computing device 404 to a particular resource provider 402 with the requested computing resource.

FIG. 5 shows an example of a computing device 500 and a mobile computing device 550 that can be used to implement the techniques described in this disclosure. The computing device 500 is intended to represent various forms of digital computers, such as laptops, desktops, workstations, personal digital assistants, servers, blade servers, mainframes, and other appropriate computers. The mobile computing device 550 is intended to represent various forms of mobile devices, such as personal digital assistants, cellular telephones, smart-phones, and other similar computing devices. The components shown here, their connections and relationships, and their functions, are meant to be examples only, and are not meant to be limiting.

The computing device 500 includes a processor 502, a memory 504, a storage device 506, a high-speed interface 508 connecting to the memory 504 and multiple high-speed expansion ports 510, and a low-speed interface 512 connecting to a low-speed expansion port 514 and the storage device 506. Each of the processor 502, the memory 504, the storage device 506, the high-speed interface 508, the high-speed expansion ports 510, and the low-speed interface 512, are interconnected using various busses, and may be mounted on a common motherboard or in other manners as appropriate. The processor 502 can process instructions for execution within the computing device 500, including instructions stored in the memory 504 or on the storage device 506 to display graphical information for a GUI on an external input/output device, such as a display 516 coupled to the high-speed interface 508. In other implementations, multiple processors and/or multiple buses may be used, as appropriate, along with multiple memories and types of memory. Also, multiple computing devices may be connected, with each device providing portions of the necessary operations (e.g., as a server bank, a group of blade servers, or a multi-processor system).

The memory 504 stores information within the computing device 500. In some implementations, the memory 504 is a volatile memory unit or units. In some implementations, the memory 504 is a non-volatile memory unit or units. The memory 504 may also be another form of computer-readable medium, such as a magnetic or optical disk.

The storage device 506 is capable of providing mass storage for the computing device 500. In some implementations, the storage device 506 may be or contain a computer-readable medium, such as a floppy disk device, a hard disk device, an optical disk device, or a tape device, a flash memory or other similar solid state memory device, or an array of devices, including devices in a storage area network or other configurations. Instructions can be stored in an information carrier. The instructions, when executed by one or more processing devices (for example, processor 502), perform one or more methods, such as those described above. The instructions can also be stored by one or more storage devices such as computer- or machine-readable mediums (for example, the memory 504, the storage device 506, or memory on the processor 502).

The high-speed interface 508 manages bandwidth-intensive operations for the computing device 500, while the low-speed interface 512 manages lower bandwidth-intensive operations. Such allocation of functions is an example only. In some implementations, the high-speed interface 508 is coupled to the memory 504, the display 516 (e.g., through a graphics processor or accelerator), and to the high-speed expansion ports 510, which may accept various expansion cards (not shown). In the implementation, the low-speed interface 512 is coupled to the storage device 506 and the low-speed expansion port 514. The low-speed expansion port 514, which may include various communication ports (e.g., USB, Bluetooth®, Ethernet, wireless Ethernet) may be coupled to one or more input/output devices, such as a keyboard, a pointing device, a scanner, or a networking device such as a switch or router, e.g., through a network adapter.

The computing device 500 may be implemented in a number of different forms, as shown in the figure. For example, it may be implemented as a standard server 520, or multiple times in a group of such servers. In addition, it may be implemented in a personal computer such as a laptop computer 522. It may also be implemented as part of a rack server system 524. Alternatively, components from the computing device 500 may be combined with other components in a mobile device (not shown), such as a mobile computing device 550. Each of such devices may contain one or more of the computing device 500 and the mobile computing device 550, and an entire system may be made up of multiple computing devices communicating with each other.

The mobile computing device 550 includes a processor 552, a memory 564, an input/output device such as a display 554, a communication interface 566, and a transceiver 568, among other components. The mobile computing device 550 may also be provided with a storage device, such as a micro-drive or other device, to provide additional storage. Each of the processor 552, the memory 564, the display 554, the communication interface 566, and the transceiver 568, are interconnected using various buses, and several of the components may be mounted on a common motherboard or in other manners as appropriate.

The processor 552 can execute instructions within the mobile computing device 550, including instructions stored in the memory 564. The processor 552 may be implemented as a chipset of chips that include separate and multiple analog and digital processors. The processor 552 may provide, for example, for coordination of the other components of the mobile computing device 550, such as control of user interfaces, applications run by the mobile computing device 550, and wireless communication by the mobile computing device 550.

The processor 552 may communicate with a user through a control interface 558 and a display interface 556 coupled to the display 554. The display 554 may be, for example, a TFT (Thin-Film-Transistor Liquid Crystal Display) display or an OLED (Organic Light Emitting Diode) display, or other appropriate display technology. The display interface 556 may comprise appropriate circuitry for driving the display 554 to present graphical and other information to a user. The control interface 558 may receive commands from a user and convert them for submission to the processor 552. In addition, an external interface 562 may provide communication with the processor 552, so as to enable near area communication of the mobile computing device 550 with other devices. The external interface 562 may provide, for example, for wired communication in some implementations, or for wireless communication in other implementations, and multiple interfaces may also be used.

The memory 564 stores information within the mobile computing device 550. The memory 564 can be implemented as one or more of a computer-readable medium or media, a volatile memory unit or units, or a non-volatile memory unit or units. An expansion memory 574 may also be provided and connected to the mobile computing device 550 through an expansion interface 572, which may include, for example, a SIMM (Single In Line Memory Module) card interface. The expansion memory 574 may provide extra storage space for the mobile computing device 550, or may also store applications or other information for the mobile computing device 550. Specifically, the expansion memory 574 may include instructions to carry out or supplement the processes described above, and may include secure information also. Thus, for example, the expansion memory 574 may be provided as a security module for the mobile computing device 550, and may be programmed with instructions that permit secure use of the mobile computing device 550. In addition, secure applications may be provided via the SIMM cards, along with additional information, such as placing identifying information on the SIMM card in a non-hackable manner.

The memory may include, for example, flash memory and/or NVRAM memory (non-volatile random access memory), as discussed below. In some implementations, instructions are stored in an information carrier. The instructions, when executed by one or more processing devices (for example, processor 552), perform one or more methods, such as those described above. The instructions can also be stored by one or more storage devices, such as one or more computer- or machine-readable mediums (for example, the memory 564, the expansion memory 574, or memory on the processor 552). In some implementations, the instructions can be received in a propagated signal, for example, over the transceiver 568 or the external interface 562.

The mobile computing device 550 may communicate wirelessly through the communication interface 566, which may include digital signal processing circuitry where necessary. The communication interface 566 may provide for communications under various modes or protocols, such as GSM voice calls (Global System for Mobile communications), SMS (Short Message Service), EMS (Enhanced Messaging Service), or MMS messaging (Multimedia Messaging Service), CDMA (code division multiple access), TDMA (time division multiple access), PDC (Personal Digital Cellular), WCDMA (Wideband Code Division Multiple Access), CDMA2000, or GPRS (General Packet Radio Service), among others. Such communication may occur, for example, through the transceiver 568 using a radio-frequency. In addition, short-range communication may occur, such as using a Bluetooth®, Wi-Fi™, or other such transceiver (not shown). In addition, a GPS (Global Positioning System) receiver module 570 may provide additional navigation- and location-related wireless data to the mobile computing device 550, which may be used as appropriate by applications running on the mobile computing device 550.

The mobile computing device 550 may also communicate audibly using an audio codec 560, which may receive spoken information from a user and convert it to usable digital information. The audio codec 560 may likewise generate audible sound for a user, such as through a speaker, e.g., in a handset of the mobile computing device 550. Such sound may include sound from voice telephone calls, may include recorded sound (e.g., voice messages, music files, etc.) and may also include sound generated by applications operating on the mobile computing device 550.

The mobile computing device 550 may be implemented in a number of different forms, as shown in the figure. For example, it may be implemented as a cellular telephone 580. It may also be implemented as part of a smart-phone 582, personal digital assistant, or other similar mobile device.

Various implementations of the systems and techniques described here can be realized in digital electronic circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor, and can be implemented in a high-level procedural and/or object-oriented programming language, and/or in assembly/machine language. As used herein, the terms machine-readable medium and computer-readable medium refer to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term machine-readable signal refers to any signal used to provide machine instructions and/or data to a programmable processor.

To provide for interaction with a user, the systems and techniques described here can be implemented on a computer having a display device (e.g., a CRT (cathode ray tube) or LCD (liquid crystal display) monitor) for displaying information to the user and a keyboard and a pointing device (e.g., a mouse or a trackball) by which the user can provide input to the computer. Other kinds of devices can be used to provide for interaction with a user as well; for example, feedback provided to the user can be any form of sensory feedback (e.g., visual feedback, auditory feedback, or tactile feedback); and input from the user can be received in any form, including acoustic, speech, or tactile input.

The systems and techniques described here can be implemented in a computing system that includes a back end component (e.g., as a data server), or that includes a middleware component (e.g., an application server), or that includes a front end component (e.g., a client computer having a graphical user interface or a Web browser through which a user can interact with an implementation of the systems and techniques described here), or any combination of such back end, middleware, or front end components. The components of the system can be interconnected by any form or medium of digital data communication (e.g., a communication network). Examples of communication networks include a local area network (LAN), a wide area network (WAN), and the Internet.

The computing system can include clients and servers. A client and server are generally remote from each other and typically interact through a communication network. The relationship of client and server arises by virtue of computer programs running on the respective computers and having a client-server relationship to each other.

In view of the structure, functions and apparatus of the systems and methods described here, in some implementations, a system and method for conducting a lottery game are provided. Having described certain implementations of methods and apparatus for supporting a lottery game, it will now become apparent to one of skill in the art that other implementations incorporating the concepts of the disclosure may be used. Therefore, the disclosure should not be limited to certain implementations, but rather should be limited only by the spirit and scope of the following claims.

Having described various embodiments of the disclosed technology, it will now become apparent to one of skill in the art that other embodiments incorporating the concepts may be used. It is felt, therefore, that these embodiments should not be limited to the disclosed embodiments, but rather should be limited only by the spirit and scope of the following claims.

Throughout the description, where apparatus and systems are described as having, including, or comprising specific components, or where processes and methods are described as having, including, or comprising specific steps, it is contemplated that, additionally, there are apparatus, and systems of the disclosed technology that consist essentially of, or consist of, the recited components, and that there are processes and methods according to the disclosed technology that consist essentially of, or consist of, the recited processing steps.

It should be understood that the order of steps or order for performing certain action is immaterial so long as the disclosed technology remains operable. Moreover, two or more steps or actions may be conducted simultaneously.

1. A method of conducting a lottery game, the method comprising the steps of:
receiving, by a processor of a computing device, a set of randomly selected winning characters;
for each of a plurality of game plays, each game play comprising a set of selected characters, determining, by a processor:
a number of and/or type of matches between the selected characters and the winning characters, and
whether the determined number and/or type of matches between the selected characters and the winning characters qualifies for at least a first prize or a second prize;
for a game play qualifying for the first prize, awarding the first prize to a first prize winner presenting the game play, wherein the first prize is a payment made in first regular installments throughout the remaining lifetime of the first prize winner; and
for a game play qualifying for the second prize, awarding the second prize to a second prize winner presenting the game play, wherein the second prize is a payment made in second regular installments throughout the remaining lifetime of the second prize winner, wherein the first regular installments have a different periodicity and different value than the second regular installments.

2. The method of claim 1, wherein the set of randomly selected winning characters comprises at least one member selected from the group consisting of: numbers, letters, and characters.

3. The method of claim 1, wherein the set of randomly selected winning characters is randomly selected using a drawing.

4. The method of claim 1, wherein the set of randomly selected winning characters is randomly selected using a drawing machine.

5. The method of claim 1, wherein the set of randomly selected winning characters is randomly selected electronically.

6. The method of claim 1, wherein the processor receiving the set of randomly selected winning characters is a first processor and the processor determining the number of matches is a second processor.

7. The method of claim 1, wherein the periodicity of the first regular installments is daily, weekly, monthly, or yearly.

8. The method of claim 7, wherein the periodicity of the second regular installments is daily, weekly, monthly, or yearly.

9. The method of claim 8, wherein the periodicity of the first regular installment is weekly and the periodicity of the second regular installment is yearly.

10. The method of claim 1, wherein the set of selected characters of a game play qualifying for the first prize match the set of randomly selected winning characters.

11. The method of claim 10, wherein the set of randomly selected winning characters consists of six characters.

12. The method of claim 1, wherein each game play of the plurality of game plays includes a play slip and the play slip includes a first matrix comprising one or more numbered squares and a second matrix comprising one or more numbered squares.

13. The method of claim 12, wherein the set of selected characters includes one or more selections of numbered squares from the first matrix and one or more selections of the numbered squares from the second matrix.

14. The method of claim 13, wherein the set of selected characters includes five selections from the first matrix and one selection from the second matrix.

15. A system comprising:
a processor; and
a memory having instructions stored thereon, wherein the instructions, when executed by the processor, cause the processor to:
receive a set of randomly selected winning characters;
for each of a plurality of game plays, each game play comprising a set of selected characters, determine:
a number of and/or type of matches between the selected characters and the winning characters, and
whether the determined number and/or type of matches between the selected characters and the winning characters qualifies for at least a first prize or a second prize;
for a game play qualifying for the first prize, award the first prize to a first prize winner presenting the game play, wherein the first prize is a payment made in first regular installments throughout the remaining lifetime of the first prize winner; and
for a game play qualifying for the second prize, award the second prize to a second prize winner presenting the game play, wherein the second prize is a payment made in second regular installments throughout the remaining lifetime of the second prize winner, wherein the first regular installments have a different periodicity and different value than the second regular installments.

16. (canceled)

17. A method of conducting a lottery game, the method comprising the steps of:
receiving, by a processor of a computing device, a set of randomly selected winning characters;
for each of a plurality of game plays, each game play comprising a set of selected characters, determining, by a processor:
a number of and/or type of matches between the selected characters and the winning characters, and
whether the determined number and/or type of matches between the selected characters and the winning characters qualifies for at least a first prize or a second prize;
for a game play qualifying for the first prize, awarding the first prize to a first prize winner presenting the game play, wherein the first prize is a payment made in first regular installments throughout the remaining lifetime of the first prize winner; and
for a game play qualifying for the second prize, awarding the second prize to a second prize winner presenting the game play, wherein the second prize is a payment made in second regular installments throughout the remaining lifetime of the second prize winner.

18. The method of claim 17, wherein the first regular installments have a different periodicity and different value than the second regular installments.

19. The method of claim 17, wherein a periodicity of the first regular installments is daily, weekly, monthly, or yearly.

20. The method of claim 17, wherein a periodicity of the second regular installments is daily, weekly, monthly, or yearly.
